(19) United States
(12) Patent Application Publication
(10) Pub. No.: US 2013/0241577 A1
(43) Pub. Date: Sep. 19, 2013

(54) CAPACITANCE TYPE SENSOR

(71) Applicant: DENSO CORPORATION, Kariya-city (JP)

(72) Inventors: Masayoshi Satake, Okazaki-city (JP); Hiroyuki Mori, Obu-city (JP); Noboru Maeda, Chiryu-city (JP); Hajime Nakagawa, Nagoya-city (JP)

(73) Assignee: DENSO CORPORATION, Kariya-city (JP)

(21) Appl. No.: 13/793,051

(22) Filed: Mar. 11, 2013

(30) Foreign Application Priority Data
Mar. 15, 2012 (JP) 2012-058963

(51) Int. Cl. G01D 5/241

(52) U.S. Cl. CPC G01D 5/2412
USPC 324/660

(57) ABSTRACT

A capacitance type sensor includes a sensor body part having a first detection electrode and a second detection electrode, which are arranged to face a detection object. The first detection electrode and the second detection electrode are arranged in a partially overlapping manner to form an overlap section. An area size of the overlap section between the first detection electrode and the second detection electrode decreases when the sensor body part deforms from a pressure exerted onto the sensor body part, in comparison to the area size of the overlap section when the sensor body part is in a normal state without deformation.

### CROSS REFERENCE TO RELATED APPLICATION

This application is based on and claims the benefit of priority of Japanese Patent Application No. 2012-58963 filed on Mar. 15, 2012, the disclosure of which is incorporated herein by reference.

### TECHNICAL FIELD

The present disclosure generally relates to a capacitance type sensor that detects a detection object based on a capacitance.

### BACKGROUND

Based on a change of capacitance between two electrodes, a capacitance type sensor is a device that detects the presence of a detection object and may identify or distinguish the type of detection object present. The capacitance type sensor may be used, for example, as a touch panel or an occupant detection sensor.

A capacitance type occupant detection sensor is, for example, disclosed in a Japanese Patent Laid-Open No. 2008-111809 (i.e., a patent document 1). The capacitance type occupant detection sensor has one electrode disposed in a seat of a vehicle, and detects, based on the change of the capacitance, whether an occupant is sitting on the seat or not, or what kind of occupant (i.e., an adult, a child in a child restraint system (CRS), or the like) is sitting on the seat. More practically, the difference between the relative dielectric constants of the detection objects (e.g., air=1, CRS=2 to 5, adult=50), which causes a change of capacitance, enables the distinctive detection of the object on the seat.

However, when a thick object exists between the detection object and a contact surface (e.g., a seat surface or a screen of a touch panel) or between the detection object and a detection electrode, the change of the capacitance by the detection object is made smaller, thereby deteriorating a detection accuracy of the capacitance type sensor.

Further, for example, when an occupant is wearing thick clothes, or when a cushion is put on a seat surface, the occupant detection sensor may have a smaller increase in capacitance, which is smaller than an expected increase. Further, when a CRS having a child sitting therein is put on the seat, a conductor of the CRS or other nearby object may form an electric field (i.e., capacitance) with the electrode of the occupant detection sensor, making the increase of the capacitance greater than expected. As a result, the smaller than expected capacitance of the adult and the greater than expected capacitance of the CRS-accommodated child may make only a small capacitance difference, and may make it difficult to establish a distinction between an adult and a child in CRS, and may deteriorate the detection accuracy of the sensor.

Further, when the touch panel is used as an interface, the touch on the touch panel screen with the user's hand covered by a glove or the like may generate a small increase in capacitance, thereby disabling the detection of the user's touch on the touch screen.

### SUMMARY

In an aspect of the present disclosure, a capacitance type sensor includes: a sensor body part, a reference electrode, a voltage application device, an electric current detector, a capacitance detector, and a detection unit. The sensor body part has a first detection electrode and a second detection electrode that are arranged to face a detection object, and the reference electrode has a reference voltage. The voltage application device applies a detection voltage to the first detection electrode and to the second detection electrode, such that an electric field is generated between the first detection electrode and the reference electrode and between the second detection electrode and an upper reference electrode.

The electric current detector detects an electric current flowing in the first detection electrode and in the second detection electrode due to the detection voltage applied thereto. The capacitance detector detects a capacitance based on the electric current detected by the electric current detector, and the detection unit distinguishingly detects the detection object based on the capacitance detected by the capacitance detection unit.

The first detection electrode and the second detection electrode are disposed in a partially overlapping manner to form an overlap section. In particular, an area size of the overlap section between the first detection electrode and the second detection electrode decreases when the sensor body part is deformed by a pressure exerted by the detection objection, in comparison to the area size of the overlap section when the sensor body part is not deformed.

In such configuration of the capacitance type sensor, when the sensor body part is displaced, a total area size of the first detection electrode and the second detection electrode that respectively form an electric field with the reference electrode increases, in comparison to the total area size when there is no displacement. Accordingly, the amount of increase of the capacitance at the time of displacement, in which the sensor body part is under pressure, is made larger, thereby enabling an accurate detection and distinction of the detection object. Specifically, the accuracy in detecting the presence of the detection object and the ability to distinguish or identify the type of the detection object improves due to the increase in the generated capacitance.

### BRIEF DESCRIPTION OF THE DRAWINGS

Other objects, features and advantages of the present disclosure will become more apparent from the following detailed description disposed with reference to the accompanying drawings, in which:

FIG. 1 is an illustration of a capacitance type sensor in a seat of a vehicle of the present disclosure;

FIG. 2 is a circuit diagram of the capacitance type sensor in a first embodiment;

FIG. 3 is a top view of a sensor body part of the first embodiment;

FIG. 4 is cross-sectional view of the sensor body part of FIG. 3 along IV-IV line of FIG. 3;

FIG. 5 is an illustration of electrodes of the sensor body part of the first embodiment in a case where the sensor body part is not deformed;

FIG. 6 is an illustration of the electrodes of the sensor body part of the first embodiment in a case where the sensor body part is deformed;

FIG. 7 is an illustration of the sensor body part of the first embodiment having a CRS disposed thereon;

FIG. 8 is an illustration of the sensor body part of the first embodiment having an adult seated thereon;

FIG. 9 is a graph comparing the capacitance detected by the capacitance type sensor of the present disclosure and by a conventional sensor;

FIG. 10 is a circuit diagram of a capacitance type sensor in a second embodiment;

FIG. 11 is a cross-sectional view of a sensor body part of the second embodiment;

FIG. 12 is an illustration of the sensor body part of the second embodiment in a case where the sensor body part is not displaced;

FIG. 13 is an illustration of the sensor body part of the second embodiment in a case where the sensor body part is displaced;

FIG. 14 is an illustration of a modification of the sensor body part having a CRS disposed thereon;

FIG. 15 is an illustration of a modification of the sensor body part having an adult seated thereon;

FIG. 16 is an illustration of a pressure distribution of the sensor body part having the adult seated thereon;

FIG. 17 is an illustration of a pressure distribution of the sensor body part having the CRS disposed thereon; and

FIG. 18 is an illustration of a modification of the sensor body part used in the second embodiment.

### DETAILED DESCRIPTION

The present disclosure describes an occupant detection sensor with reference to the drawings. The drawings used in the description of the following embodiments depict a concept of the present disclosure, and may not reflect the dimensions of an actual product.

### First Embodiment

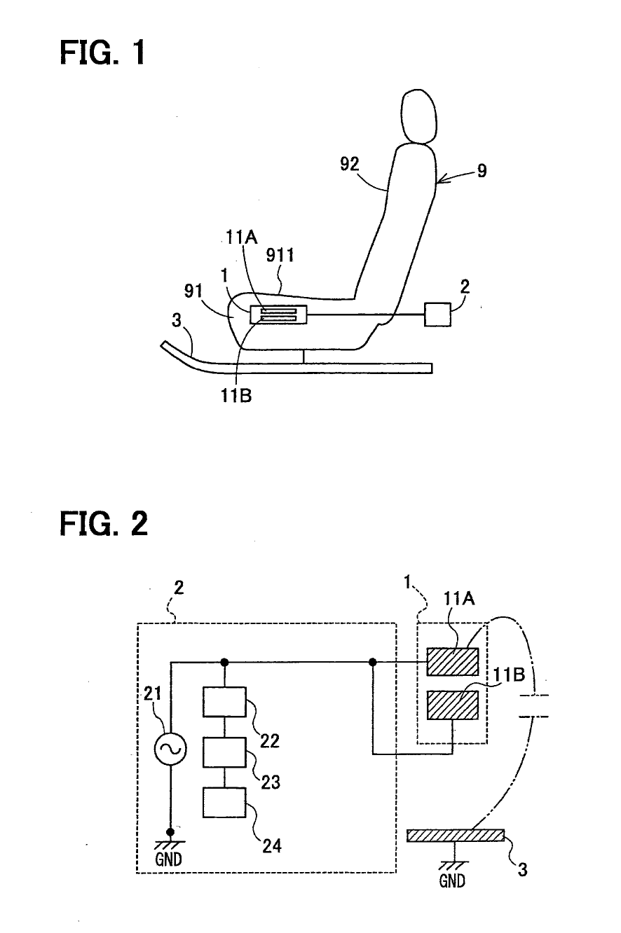

With reference to FIGS. 1 and 2, a capacitance type sensor includes a sensor body part 1, an occupant detection ECU 2, and a vehicle body 3. The sensor body part 1 is a film like sensor mat, which is disposed in a seat part 91 of a seat 9 in a vehicle (e.g., in between cushions of the seat 9). The seat 9 has a seat part 91 and a back part 92. Further, the seat part 91 has a seat surface 911, which is contacted by a detection object, such as an occupant, when the detection object is on the seat part 91.

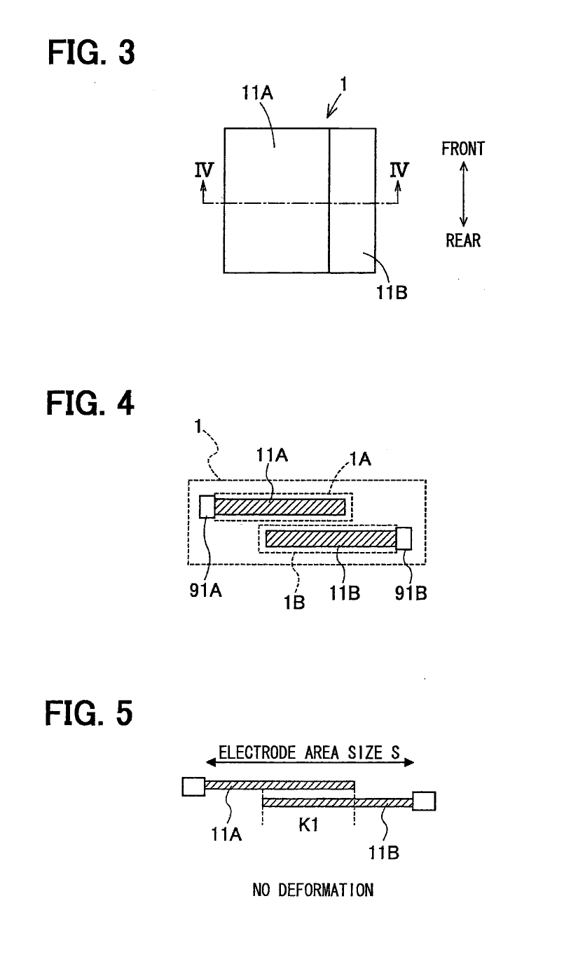

With reference to FIGS. 3 and 4, the sensor body part 1 when viewed from the seat surface 911, has a rectangular body with two separate mats that overlap. In particular, the sensor body part 1 includes a first detection electrode 11A and a second detection electrode 11B. The first detection electrode 11A is inserted between two pieces of film members (not illustrated) made of insulation material (e.g., PET) and serves as a first sensor part 1A. Similarly, the second detection electrode 11B is inserted between two pieces of film members (not illustrated) and serves as a second sensor part 1B.

The first detection electrode 11A and the second detection electrode 11B are a flat board-shaped conductive material, and are disposed in the sensor body part 1. The first detection electrode 11A is part of one of the two separate mats (i.e., in the first sensor part 1A of the sensor body part 1), and the second detection electrode 11B is part of the other of the two separate mats (i.e., in the second sensor part 1B of the sensor body part 1).

Further, the first detection electrode 11A and the second detection electrode 11B are respectively connected to a voltage application device 21 and to an electric current detector 22 (FIG. 2).

The first detection electrode 11A and the second detection electrode 11B are arranged within the sensor body part 1 to be substantially parallel with the seat surface 911, such that a surface of the first detection electrode 11A and the second detection electrode 11B face the seat surface 911. In other words, the first detection electrode 11A and the second detection electrode 11B are positioned to face the detection object when the detection object is disposed within in a detection range (i.e., the detection range may be provided as the seat surface 911). Also, when discussing the features of the first detection electrode 11A and the second detection electrode 11B, the first detection electrode 11A and the second detection electrode 11B may be referred to as a detection electrode 11A, 11B for brevity.

With continuing reference to FIG. 2, the occupant detection ECU 2 is an electronic control unit that includes the voltage application device 21, the electric current detector 22, a capacitance detector 23, and a detection unit 24. The voltage application device 21 is connected to a vehicle ground GND and to the detection electrode 11A, 11B. The voltage application device 21 is an AC (i.e., alternating) power supply, and applies an AC voltage (i.e., a detection voltage) to the detection electrode 11A, 11B. In such manner, the detection electrode 11A, 11B forms an electric field in a space provided between the detection electrode 11A,11B and the vehicle body 3, which is connected to the GND (i.e., the space may also be designated as a “detection-body gap space”).

The electric current detector 22 is an electric current sensor, and detects an electric current flowing in the detection electrode 11A, 11B, where the electric current is caused by the voltage applied by the voltage application device 21.

The capacitance detector 23 is connected to the electric current detector 22 and to the detection unit 24. The capacitance detector 23 calculates capacitance in the electric field that is formed by the detection electrode 11A, 11B, based on the voltage that is applied by the voltage application device 21 and the electric current detected by the electric current detector 22. The capacitance is calculated based on an imaginary part of the impedance in the electric current path at a time of application of the voltage, and the imaginary part of the impedance is calculated based on a phase shift between the electric current and the voltage.

Based on a detection result of the capacitance detector 23 and a predetermined threshold, the detection unit 24 determines whether an occupant is sitting on the seat 9, and determines whether the occupant, who is sitting on the seat, is an adult or a child in a car seat (CRS).

The vehicle body 3 is a body of the vehicle, and serves as an electrode, that has a voltage of the vehicle ground GND, which is a reference electric potential.

With reference to FIGS. 3 and 4, the sensor body part 1 is arranged such that the first detection electrode 11A is layered partially on top of the second detection electrode 11B. In other words, if seen from the seat surface 911 (i.e., top view of the seat part 91 of FIG. 3), the first detection electrode 11A partially covers the second detection electrode 11B. Accordingly, the second detection electrode 11B is partially hidden under the first detection electrode 11A.

Further, when the detection object is sitting on the seat part 91, the sensor body part 1 is displaced due to the pressure exerted by the detection objection. As a result, the first detection electrode 11A and the second detection electrode 11B are also displayed. In particular, the displacement of the first sensor part 1A due to the pressure exerted by the detection object, causes the first sensor part 1A to exert a pressure onto the second sensor part 1B, thereby displaying the second sensor part 1B.

With continuing reference to FIG. 4, a left end of the first sensor part 1A is fixed to a left connection part 91A provided inside of the seat part 91. The second sensor part 1B is disposed under the first detection electrode 11A at a shifted position towards the right. A right end of the second sensor part 1B is fixed to a right connection part 91B, which is also inside of the seat part 91.

The left end of the first detection electrode 11A and the right end of the second detection electrode 11B are fixed, either directly or indirectly through the film member to the left connection part 91A and the right connection part 91B, respectively. In addition, the left connection part 91A and the right connection part 91B may be a urethane portion of the seat part 91.

As described above, the first detection electrode 11A has a board shaped body that is arranged to be substantially parallel with the seat surface 911, and has its left end fixed to the seat part 91 via the left connection part 91A. The second detection electrode 11B also has a board shaped body that is substantially parallel with the seat surface 911 and below the first detection electrode 11A, and has its right end fixed to the seat part 91 via the right connection part 91B.

The left end of the first detection electrode 11A and the right end of the second detection electrode 11B are affixed to the seat part 91 such that when the detection object is positioned on the seat part 91, the left end of the first detection electrode 11A and the right end of the second detection electrode 11B remain affixed to the seat part 91. In particular, in a top view of the sensor body part 1 (FIG. 3) a left side of the first detection electrode 11A, which extends along a front-rear axis, remains affixed to the seat part 91 even against the pressure exerted by the detection object. Similarly, a right side of the second detection electrode 11B, which extends along the front-rear axis, remains affixed to the seat part 91 even against the pressure exerted by the detection object.

The pressure exerted by the detection object is in a downward direction that is perpendicular to a plane defined by the board shaped body of the first detection electrode 11A and a plane defined by the board shaped body of the second detection electrode 11B.

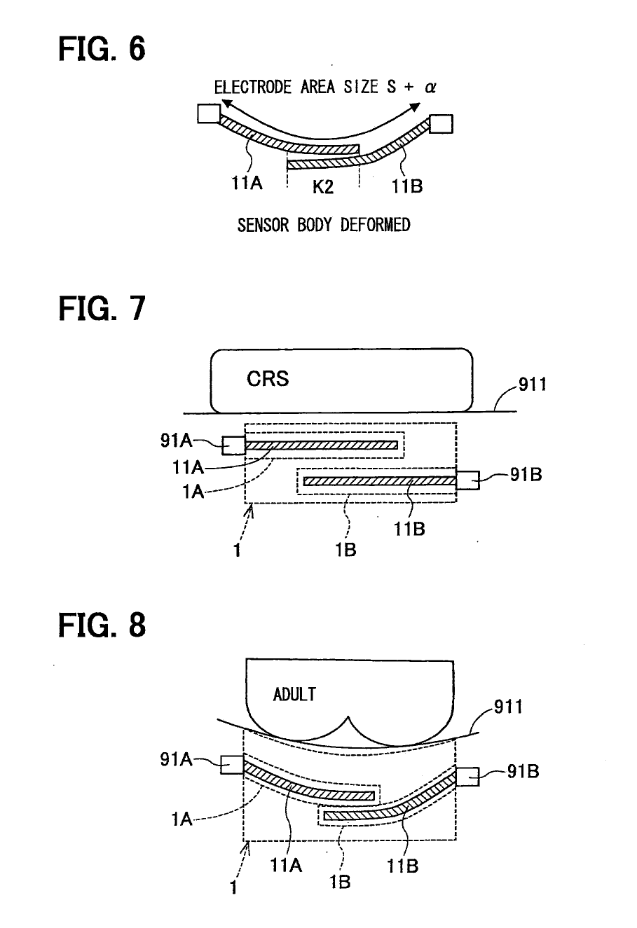

With reference to FIGS. 5 and 6, when no pressure is exerted onto the sensor body part 1 (i.e., non-displaced or non-deformed state), the first detection electrode 11A and the second detection electrode 11B may overlap by an overlap area K1. When pressure is exerted onto the sensor body part 1 (i.e., a displaced or deformed state), the first detection electrode 11A and the second detection electrode 11B may overlap by an overlap area K2, which is smaller than K1. Due to the structure of the sensor body part 1, the overlap area of the first detection electrode 11A and the second detection electrode 11B is smaller in the displaced state of the sensor body part 1 than a non-displaced state of the sensor body part 1 (i.e., K2<K1).

Therefore, if an electrode area size S, which represents an area at a time of no pressure from the seat surface 911 (i.e., when the sensor body part 1 is not deformed), the electrode area size at a time of deformation under pressure may be designated as S+α. In other words, the sensor body part 1 deformed under pressure from the detection object, which is on the seat surface 911, has a greater area size than the sensor body part 1 that is not deformed by an amount of area that was displaced by the detection object (i.e., α).

The sensor body part 1 in a displaced state has a greater electric field formation area than the sensor body part 1 in a non-displaced state, in which the electric field formation area forming an electric field with a reference electrode is a total area of the two electrodes 11A and 11B, allowing a partial overlap therebetween. Therefore, the sensor body part 1 in a displaced state has an increase of detected capacitance than the sensor body part 1 in a non-displaced state, when the capacitance is detected by the capacitance detector 23.

With reference to FIGS. 7 and 8, when a CRS having a child sitting thereon is arranged on the seat surface 911, a pressure from the CRS against the seat surface 911 is evenly distributed on the seat surface 911, and no partial displacement is caused to the sensor body part 1.

On the other hand, when an adult is seated on the seat surface 911, a pressure from a hip portion and a thigh portion is greater than a pressure from other contacting portions, causing a partial displacement (i.e., a partial depression) of the sensor body part 1. In particular, a right-side end of the first detection electrode 11A is pressed down, and a left-side end of the second detection electrode 11B is pressed down by the first detection electrode 11A. In such manner, the area size of the electrode increases due to the displacement of the detection electrodes 11A, 11B caused by the adult, thereby increasing a total capacitance in proportion to the increased electrode area size.

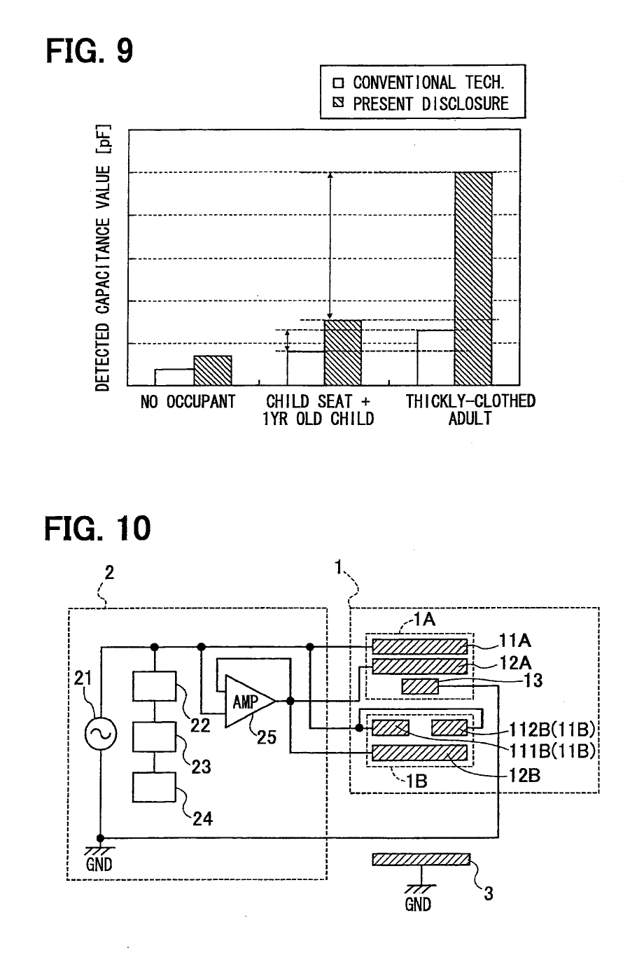

With reference to FIG. 9, a comparison between the capacitance generated using a conventional technique and the capacitance generated based on sensor body unit 1 of the present disclosure is provided for three different cases. The three cases provided are: no occupant, a CRS with a one year old child, and a thickly clothed adult. For all three cases the capacitance generated increased in comparison to the conventional technique.

Further, the difference between the capacitance detected for the CRS with the one year old child and the thickly-clothed adult significantly increased when compared to the difference using the conventional technique. Such a difference between the two cases is about seven times more than the difference using the conventional technique.

The significant increase in the difference between the two capacitance is caused by the partial displacement of the sensor body part 1 that increases the electrode area size by the amount displaced by the adult seated in the seat 9. The significant difference in capacitance allows for a clearer and securer determination for distinguishing between the detection objects, such that the greater the difference in capacitance the easier the distinction between the two cases. That is, the CRS case and the adult case can be accurately distinguished from each other regardless of whether the occupant is thickly-closed or not. A threshold used to distinguish between detection objects may be set to, for example, a middle value of the two capacitance values.

A part of the second detection electrode 11B that is overlapping with the first detection electrode 11A serves as a guard electrode of the first detection electrode 11A. The guard electrode, in combination with the detection electrode, forms an electric field wrapping the detection object against the reference electrode. The guard electrode is described in detail in the second embodiment.

Therefore, according to the present embodiment, a guard function may be provided without having the guard electrode. However, by having the guard electrode, the guard function is securely provided. In other words, the first sensor part 1A has a guard electrode at a lower part of the first detection electrode 11A with a film member interposed therebetween. Further, the second sensor part 1B has a guard electrode at a lower part of the second detection electrode 11B with a film member interposed therebetween. Each of the guard electrodes has substantially the same voltage as the detection electrode, which is applied thereto by the voltage application device 22 through an op-amp. The lower part of each of the guard electrodes is protected by a film member. The sensor parts 1A, 1B may respectively have a guard electrode in the above-described manner.

### Second Embodiment

The capacitance type sensor in the second embodiment of the present disclosure is described with reference to FIGS. 10 to 15. The difference of the capacitance type sensor in the second embodiment from the one in the first embodiment exists in a configuration of the sensor body part, which is described in detail in the following description.

As illustrated in FIG. 10, the sensor body part 1 of the present embodiment includes the first sensor part 1A and the second sensor part 1B which partially overlaps with the first sensor part 1A on its lower side. The first sensor part 1A includes the first detection electrode 11A, a first guard electrode 12A, and a sub-reference electrode 13, together with four pieces of film members which are not illustrated.

The electrodes 11A, 12A, 13 and four film members constituting the first sensor part 1A are alternatively arranged in order from top to bottom. That is, from a seat surface 911 side to a vehicle body 3 side, a film member, the first detection electrode 11A, a film member, the first guard electrode 12A, a film member, the sub-reference electrode 13, and a film member are disposed in this order. An adhesive may be interposed between the film members.

The second sensor part 1B includes the second detection electrode 11B and a second guard electrode 12B together with three pieces of film members which are not illustrated. The electrodes 11B, 12B and three film members constituting the second sensor part 1B are alternatively disposed from top (i.e., the seat surface 911 side) to bottom (i.e., the vehicle body 3 side) in an arrangement order of a film member, the second detection electrode 11B, a film member, the second guard electrode 12B, and a film member. The second detection electrode 11B is divided into two parts 111B, 112B, which will be described later in more detail. An adhesive is interposed between the film members.

The first guard electrode 12A and the second guard electrode 12B have the same configuration as the detection electrodes 11A, 11B, and are connected to an op-amp 25. The sub-reference electrode 13 has basically the same configuration as the detection electrodes 11A, 11B but has a smaller width than the detection electrodes 11A, 11B. The sub-reference electrode 13 is connected to the vehicle ground GND, which has the reference electric potential.

The occupant detection ECU 2 of the present embodiment includes the op-amp 25. The op-amp 25 has the voltage application device 21 connected to its input terminal, and has its output terminal connected to the guard electrodes 12A, 12B. The op-amp 25 applies the same voltage that is applied to the detection electrodes 11A, 11B to the guard electrodes 12A, 12B. In such manner, the detection electrodes 11A, 11B have the same voltage as the guard electrodes 12A, 12B.

The guard electrodes 12A, 12B on the lower side of the electrodes 11A, 11B (i.e., on an opposite side of the seat surface 911) prevent a formation of an electric field between the detection electrodes 11A, 11B and the vehicle body 3 or the sub-reference electrode 13, by having the same reference voltage as the detection electrodes 11A, 11B. In other words, the guard electrodes 12A, 12B constrain the electric field formed by the detection electrodes 11A, 11B towards the seat surface 911.

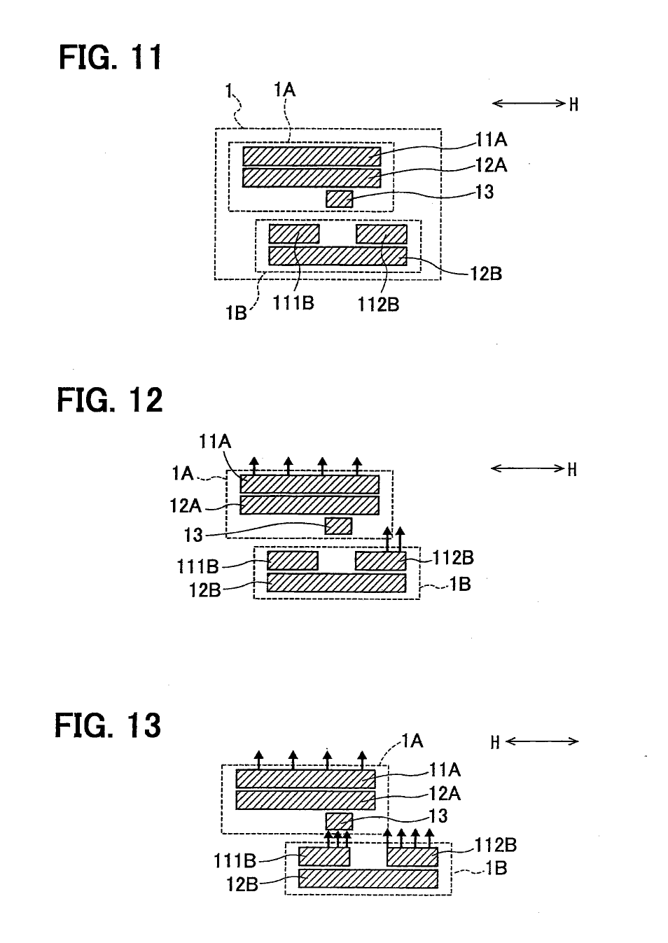

As shown in FIG. 11, the sub-reference electrode 13 in first sensor part 1A has a smaller width than the first detection electrode 11A and the first guard electrode 12A (i.e., the width is a size measured along a horizontal axis (“H”-axis)). The sub-reference electrode 13 is disposed at a position facing a center of the width of the second sensor unit 1B (i.e., the center of the second sensor unit 1B along the horizontal axis).

The second detection electrode 11B of the second sensor part 1B has its width divided into two parts to form the second detection electrode 111B, 112B. The second detection electrode 111B is positioned on a left side of the second sensor part 1B (i.e., on a left side of the drawing). The second detection electrode 112B, is disposed on the right side of the second sensor part 1B (i.e., on a right side of the drawing).

The second detection electrodes 111B, 112B are arranged with a gap interposed therebetween. In particular, the gap between the second detection electrodes 111B, 112B is at the center of the width of the second sensor part 1B.

The sub-reference electrode 13 in the first sensor part 1A is arranged, such that it is over the gap between the second detection electrodes 111B, 112B. In other words, the sub-reference electrode 13 is substantially disposed above a no electrode position where no detection electrode is disposed.

The second guard electrode 12B is formed as one piece of conductive material, and is positioned below the second detection electrodes 11B. In particular, the second guard electrode 12B, as one piece, extends the width of the second detection electrodes 111B, 112 and the gap therebetween.

With reference to FIG. 11, the second sensor part 1B is partially overlapping with the first sensor part 1A, and has a shifted position against the first sensor part 1A towards the right. In particular, the second detection electrode 111B and a portion of 112B is covered by the first sensor part 1A, and the remaining portion of the second detection electrode 112B is not covered by the first sensor part 1A. Therefore, the portion of the second detection electrode 112B that is not under the first sensor part 1A forms an electric field through the occupant (i.e., allowing a formation of an electric field in a detection-body gap space).

When the sensor body part 1 is in a non-displaced state (FIG. 12), the first detection electrode 11A and a portion of the second detection electrode 112B, which is not covered by the first detection electrode 11A, form an electric field with the vehicle body 3.

On the other hand, when the sensor body part 1 is in a displaced state (FIG. 13), the first sensor part 1A and the second sensor part 1B are displaced from each other along the horizontal axis, which is along a width of the sensor body unit 1. In particular, the first sensor part 1A and the second sensor part 1B are displaced such that a larger portion of the second detection electrode 112B is exposed from under the first sensor part 1A to form an electric field toward the occupant, thereby leading to an increase of the capacitance formed by the second detection electrode 112B in the detection-body gap space.

Further, in the displaced state, a relative movement of the sub-reference electrode 13 causes a mutually-facing positioning of the second detection electrode 111B and the sub-reference electrode 13. In other words, the sub-reference electrode 13 and the second detection electrode 11B move such that it overlaps with the second detection electrode 111B. Therefore, an electric field is formed between two electrodes, and the capacitance from such electric field in the detection-body gap space contributes to an increase of the total amount of capacitance.

Even when the sub-reference electrode 13 does not move, the capacitance in the detection-body gap space can be detectable. According to the second embodiment described above, a capacitance difference between an adult case and a CRS case may be made greater, that is, greater than the capacitance difference in the first embodiment, thereby increasing the accuracy of detecting and identifying the detection object.

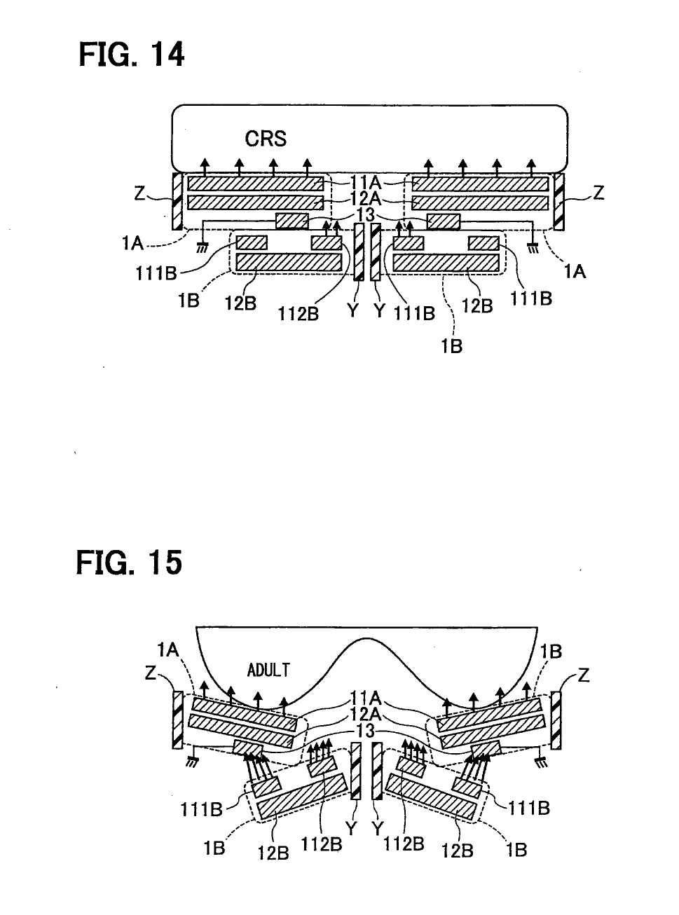

With reference to FIGS. 14 and 15, in which the seat surface 911 is omitted from the drawing, the sensor body part 1 has two sensor parts 1. In particular, the first sensor part 1A and the second sensor part 1B are arranged in symmetry, respectively as one set of sensors. The following description is about one set of sensors on the left side, i.e., the left side set of sensors, for the brevity of the description.

The first sensor part 1A is fixed onto a left connection part Z of the seat part 91. The second sensor part 1B is arranged below the first sensor part 1A and is shifted towards the right. A right edge of the second sensor part 1B is fixed onto a fixed part Y, which is positioned at a center of the seat part 91. In such manner, one end of the sensor part 1A and one end of the sensor part 1B are respectively fixed onto the seat part 91.

When a CRS is disposed on the seat surface 911 FIG. 14, the sensor body part 1 is hardly displaced, since a pressure from the CRS is evenly distributed across the sensor body part 1. In such a state, the capacitance in the detection-body gap space and the capacitance between the second detection electrode 111B and the sub-reference electrode 13 are respectively detected as described with respect to the non-displaced state.

On the other hand, when an adult sits on the seat surface 911 (FIG. 15), the contacting parts of the adult, such as the posterior and thigh, press the sensor body part 1, displacing the sensor body part 1. Specifically, the right-side end of the first sensor part 1A is pressed down, which presses down on the left-side end of the second sensor part 1B.

In such manner, a greater portion of the second detection electrode 112B is exposed from under the first detection electrode 11A (i.e., having a greater exposure area size due to the displacement caused by the adult). In addition, the sub-reference electrode 13 moves such that it is facing the second detection electrode 111B. As a result, the capacitance increases.

Further, an increase of the total capacitance is greater in a case where the detection object is an adult than a case where the detection object is a CRS due to the increase of the area size of the electrode that is generated by the displacement caused by the adult.

<Modification>

The present disclosure may be modified in the following manner.

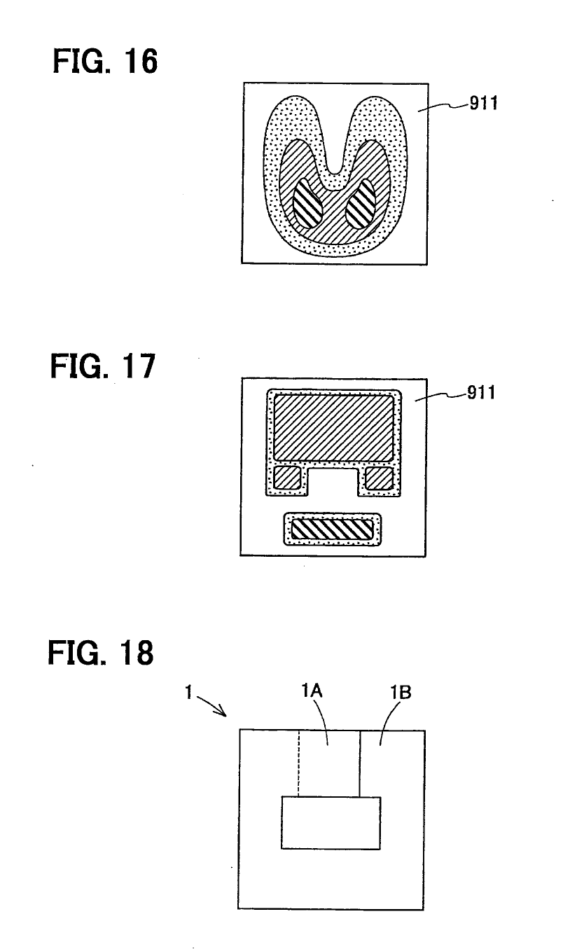

With reference to FIGS. 16 and 17, the sensor body part 1 may be configured based on a pressure distribution of an occupant seated on the seat surface 911.

FIGS. 16 and 17 show a conceptual diagram, in which a dotted portion has a higher pressure than a white portion, a thin slant line portion has a higher pressure than the dotted portion, a thick slant line portion has a higher pressure than the thin slant line portion (i.e., white<dot<thin slant line<thick slant line). FIG. 16 represents the pressure distribution of an adult seated on the seat surface 911, and FIG. 17 represents the pressure distribution of an CRS arranged on the seat surface 911. Accordingly, based on the pressure distribution, the sensor body part 1, as illustrated by FIGS. 8 and 15, may be arranged along the posterior and/or the thigh position so that a greater capacitance can be generated in a securer manner.

The detection unit 24 may be disposed in another ECU (e.g., in an airbag ECU) instead of disposed in the occupant detection ECU 2.

Further, the sensor body part 1 may have an electrode (not illustrated) for detecting a liquid spill. A liquid spill detection electrode may be disposed along the detection electrodes 11A, 11B substantially along the same plane as the detection electrodes 11A, 11B. In other words, the liquid spill detection electrode may be disposed next to the detection electrodes 11A, 11B with a space interposed therebetween.

When an occupant is detected, the liquid spill detection electrode has the same voltage as the detection electrodes 11A, 11B. When a liquid spill is detected, the liquid spill detection electrode has the same voltage as the reference voltage and a capacitance is detected between the detection electrodes 11A, 11B and the liquid spill detection electrode. Based on the capacitance in a “detection-spill gap space,” a liquid spill onto the seat surface 911 is detected.

Further, in the sensor body part 1, the first detection electrode 11A and the second detection electrode 11B may simply be formed as separate parts, and the first sensor part 1A and the second sensor part 1B may simply be formed as separate parts, as long as the electrodes 11A/B and the sensor parts 1A/B are separately and individually displaceable. More practically, the first detection electrode 11A and the second detection electrode 11B may simply have their facing ends separated from each other, and the first sensor part 1A and the second sensor part 1B may simply have those facing ends separated from each other.

Further, as for the sensor body part 1, the first sensor part 1A and the second sensor part 1B may respectively have a separate body. When they have separate bodies, each of the detection electrodes or each of the sensors may be connected to the occupant detection ECU 2, and the voltage application device 21 may apply the voltage to each of them, and the electric current detector 22 may detect an electric current in each of them.

The degree of freedom of the positioning of the parts may be increased by forming the first detection electrode 11A, the second detection electrode 11B, the first sensor part 1A and the second sensor part 1B as respectively separate parts, the production of the sensor body part may be made easier as well. For example, the sensor body part 1 in the first embodiment may have long board shape as the first and second sensor parts 1A, 1B.

On the other hand, in case that the sensor body part 1 is formed in one body (i.e., in a slit formation) production steps and man-hours may be reduced. In the second embodiment, if the sensor body part 1 has one body (i.e., one-piece molding), the sensor body part 1 may have a configuration in FIG. 18. In such configuration, the first detection electrode 11A and the second detection electrode 11B are connected on one end, and the first sensor part 1A and the second sensor part 1B are connected on one end.

Further, the guard electrode 12 is dispensable. However, having the guard electrode 12 provides a securer formation of the electric field through the detection object.

The above-described modification examples respectively have the same advantageous effects as the base embodiment that serves as a basis of such modification. Further, the drawing of the modification examples has a film member omitted therefrom.

Further, the present disclosure may be applicable to a touch/contact detection sensor of a touch panel device. For example, if we consider the press by the hip of an adult in FIG. 8 and FIG. 15 as a press performed by a finger, the same effects and advantages are expected. According to the present disclosure, when a displaceable flexible touch screen (i.e., a contact surface) is pressed by a finger or the like, the touch screen and the sensor body part 1 are displaced, and an increase of the capacitance is detected as described in the above embodiments. In such a case, the capacitance type sensor in the present disclosure is formed/disposed in a case (i.e., a body) having the touch screen. Such case/body or the seat part 91 may serve as a body part accommodating the sensor body part 1, and the touch screen and the seat surface 911 may serve as a contact surface that contacts the detection object.

Further, the present disclosure may have no contact surface. That is, the detection object may be directly pressed against the sensor body part, the detection electrode, the first sensor part and/or the second sensor part.

In other words, pressing of the sensor body part by the detection object may be direct, or may be indirect through a contact surface such as the seat surface 911, the screen or the like.

Although the present disclosure has been fully described in connection with the preferred embodiment thereof with reference to the accompanying drawings, the process is to be noted that various changes and modifications will become apparent to those skilled in the art, and such changes and modifications are to be understood as being within the scope of the present disclosure as defined by the appended claims.

What is claimed is:

1. A capacitance type sensor comprising:
a sensor body part having a first detection electrode and a second detection electrode, wherein the first detection electrode and the second detection electrode are arranged to face a detection object;
a reference electrode having a reference voltage;
a voltage application device applying a detection voltage to the first detection electrode and to the second detection electrode, and generating an electric field between the first detection electrode and the reference electrode and between the second detection electrode and an upper reference electrode;
an electric current detector detecting an electric current flowing in the first detection electrode and in the second detection electrode due to the detection voltage applied thereto;
a capacitance detector detecting a capacitance based on the electric current detected by the electric current detector; and
a detection unit distinguishingly detecting the detection object based on the capacitance detected by the capacitance detector, wherein
the first detection electrode and the second detection electrode are disposed in a partially overlapping manner to form an overlap section, and
an area size of the overlap section between the first detection electrode and the second detection electrode decreases when the sensor body part is deformed by a pressure exerted from the detection objection, in comparison to the area size of the overlap section when the sensor body part is not deformed.

2. The capacitance type sensor of claim 1, wherein
the first detection electrode has one end fixedly disposed, such that the one end of the first detection electrode remains affixed against a pressure exerted from the detection object, and
the second detection electrode has one end fixedly disposed, such that the one end of the second detection electrode remains affixed against a pressure exerted from the detection object, the one end of the second detection electrode is opposite to the one end fixedly disposed of the first detection electrode.

3. The capacitance type sensor of claim 1, wherein
the sensor body part is disposed inside of a seat part of a seat in a vehicle,
the reference electrode is a vehicle body, and
the detection unit distinguishably detects an occupant in the vehicle based on the capacitance detected by the capacitance detector.

4. The capacitance type sensor of claim 3, wherein
the sensor body part is arranged according to a pressure distribution caused by the occupant seated on the seat part.
